(19) United States
(12) Patent Application Publication
(10) Pub. No.: US 2010/0153573 A1
(43) Pub. Date: Jun. 17, 2010

(54) Methods and Apparatus to Provide Content

(75) Inventor: Andy Huang, West Chicago, IL (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/333,843

(22) Filed: Dec. 12, 2008

(51) Int. Cl. G06F 15/16; H04L 1/08; H04L 13/00; G06F 11/10

(52) U.S. Cl. 709/231; 714/748; 714/799; 714/E11.004

(57) ABSTRACT

Method and apparatus to provide media content are presented. In a particular embodiment, a method of providing content includes receiving a request of particular content at a computing device, where the request is addressed to a unicast source, and determining whether the particular content is available, at least in part, via at least one multicast group accessible by the computing device. The method also includes, when the particular content is available, at least in part, via the at least one multicast group, sending a group join request from the computing device to a network element of a multicast network to join the at least one multicast group.

### FIELD OF THE DISCLOSURE

The present disclosure is generally related to providing content.

### BACKGROUND

As the Internet grows, demand for content, such as video content distributable over the Internet also grows. Currently, many service providers utilize a content delivery system that includes a collection of servers or service nodes to deliver content. Typically, when a user requests content, the content is delivered by a unicast (one-to-one) transmission. Unicast transmission may be a reliable method of transmission to a subscriber. However, unicast transmission can be a time-consuming way to transfer data to a user.

### BRIEF DESCRIPTION OF THE DRAWINGS

FIG. 1 is a block diagram of a first embodiment of a system to provide content;

FIG. 2 is a flow diagram of an embodiment of a method to provide content;

FIG. 3 is a flow diagram of a second embodiment of a method to provide content;

FIG. 4 is a flow diagram of a third embodiment of a method to provide content; and

FIG. 5 is a general diagram of a particular illustrative embodiment of a computer system.

### DETAILED DESCRIPTION

In a particular embodiment, a method of providing content is presented and includes receiving a request for particular content at a computing device. The request is addressed to a unicast source. The method includes determining whether the particular content or portion thereof is available via at least one multicast group accessible by the computing device. The method also includes, when the particular content or portion thereof is available via the at least one multicast group, sending a group join request from the computing device to a network element of a multicast network to join the at least one multicast group.

In another particular embodiment, a computing device is presented and includes an input and proxy logic. The input is to receive a request of particular content. The request is addressed to a unicast source. The proxy logic is to determine whether the particular content is available at least in part via at least one multicast group accessible by the computing device. When the particular content is available via the at least one multicast group, the computing device is configured to send a group join request to a network element of a multicast network to join the at least one multicast group.

In another particular embodiment, a computer-readable medium is presented and includes computer-executable instructions that when executed, cause the computer to receive a request for particular content at a computing device, where the request is addressed to a unicast source. The computer-executable instructions, when executed, further cause the computer to determine whether the particular content is available at least in part via at least one multicast group accessible by the computing device. When the particular content is available at least in part via the at least one multicast group, the computer sends a group join request to a network element of a multicast network to join the at least one multicast group.

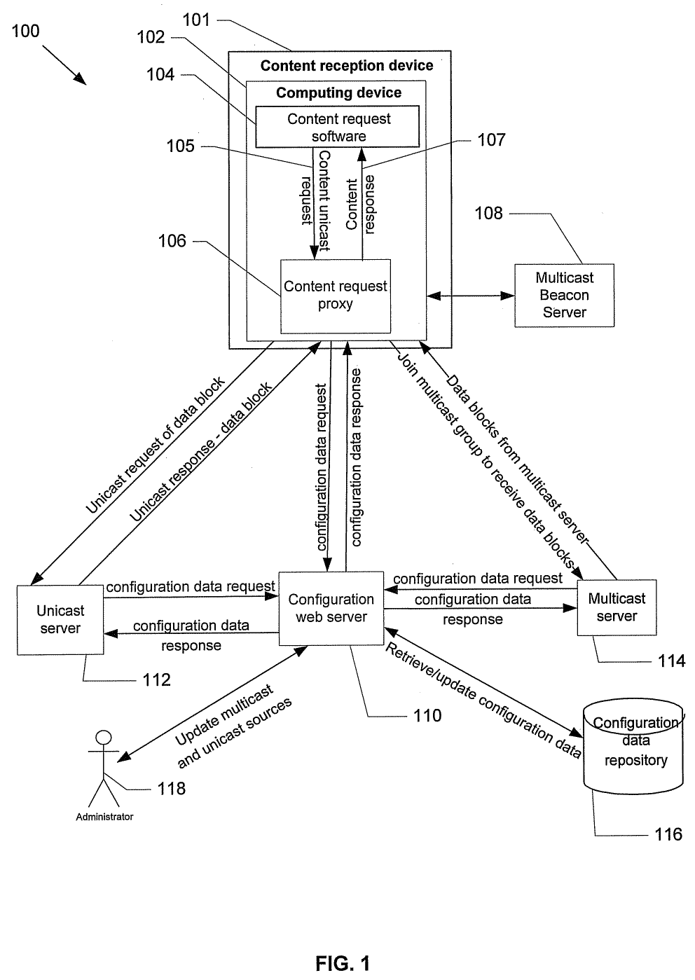

FIG. 1 is block diagram of a first embodiment of a system to provide content. The system 100 includes a content reception device 101, a unicast server 112, a configuration web server 110, a multicast server 114, a configuration data repository 116, and a multicast beacon server 108.

The content reception device 101 is configured to communicate with the configuration web server 110, with the unicast server 112, and with the multicast server 114. The content reception device 101 is also configured to communicate with the multicast beacon server 108.

The unicast server 112 is configured to communicate with the content reception device 101. The unicast server 112 is also configured to communicate with the configuration web server 110.

The configuration web server 110 is configured to communicate with the content reception device 101, with the unicast server 112, with the multicast server 114, and with the configuration data repository 116. The configuration web server 110 is also configured to communicate with a system administrator 118 via an administrator user interface.

The multicast server 114 is configured to communicate with the content reception device 101 and with the configuration web server 110.

The content reception device 101 includes a computing device 102. The computing device 102 can include content request software 104 and can also include a content request proxy 106. In a particular illustrative embodiment, the content request proxy 106 is a software application. The content request software 104 may generate a request, such as a content unicast request 105, that is input to the content request proxy 106. In a particular illustrative embodiment, the content unicast request 105 is a request to receive requested content that is to be delivered by a unicast transmission. In response, the content request proxy 106 provides a content response 107 to the content request software 104, which may provide an output from the content reception device 101 to a display device (not shown). In a particular illustrative embodiment, the content response 107 includes the requested content, which may have been retrieved by a unicast transmission, a multicast transmission, or a combination thereof.

In operation, the content reception device 101 may receive a request from a user to receive particular content (“requested content”). For example, the requested content may be video content, such as movies or television programs, audio presentations, or any combination thereof. The user may input the request indicating a selection of particular content to be displayed. In a particular illustrative embodiment, the user inputs the selection of particular content via an input device such as a remote input, a keyboard, or another input device. The user input may be received at the computing device 102 from the content reception device 101. Within the content reception device 101, the computing device 102 executing the content request software 104 may generate the content unicast request 105, which can be sent to the content request proxy 106 (“proxy”) within the computing device 102.

In a particular illustrative embodiment, the content request proxy 106 determines whether the computing device 102 is coupled to a multicast network by determining whether the computing device 102 is receiving a multicast beacon emanating from the multicast beacon server 108. The computing device 102, executing the content request proxy 106, can also determine whether the requested content is available at least in part via at least one multicast group that can be accessed by the computing device 102. In a particular illustrative embodiment, the requested content includes a plurality of data blocks that are supplied by a variety of sources including multicast sources and unicast sources.

In a particular illustrative embodiment, the proxy 106 generates a configuration data request that is transmitted from the computing device 102 to the configuration web server 110. In response, the configuration web server 110 provides a configuration data response that includes a content table to the computing device 102. The content table may be accessed through the configuration web server 110. The computing device 102 can access the content table to retrieve configuration data associated with a source of at least a portion of the requested content.

The computing device 102, executing the content request proxy 106, can determine whether the requested content is available at least in part via at least one multicast group by accessing the content table, which can indicate content availability from each of a plurality of multicast groups. The content table can include an address of at least one multicast group. The content table can also include an address of at least one unicast group.

The content table can indicate which of one or more multicast sources, such as multicast server 114, is configured to provide at least a portion of the requested content. The content table may also include an indication of one or more unicast servers, such as the unicast server 112, that can provide at least a portion of the requested content. The content table may also include an indication of a geographic location of each of the multicast sources and each of the unicast sources. From the content table, the proxy 106 can identify one or more multicast sources that are determined to be closer than other sources to the content reception device 101 (“closest multicast sources”). From the content table, the proxy 106 can identify one or more multicast sources that are identified to be closer than other unicast sources to the content reception device 101 (“closest unicast sources”).

In a particular illustrative embodiment, the configuration web server 110 can retrieve and/or update configuration data that can be provided by the configuration data repository 116. The configuration data provided by the configuration data repository 116 can include updates to the content table including available multicast or unicast sources of the requested content. The configuration web server 110 may also be in contact with an administrator 118, providing additional updates to the configuration web server 110 that can include a list of multicast and unicast sources that are able to supply content.

The configuration web server 110 may also provide configuration data that includes metadata related to the requested content. The metadata may include content name, verification data (e.g., checksum) related to the content, number of data blocks to be sent, a data block checksum associated with each data block, and designated multicast and unicast sources that can send a portion of the data blocks. In a particular embodiment, the configuration web server 110 can provide a web interface to update content availability. In a particular illustrative embodiment, the multicast server 114 sends an HTTP request to receive configuration data from the configuration web server 110. In response, the configuration web server 110 provides to the multicast server 114 configuration data that can include an indication of which multicast sources are to provide particular content data blocks of the requested content.

In a particular embodiment, the computing device 102 receives a portion of the requested content from a unicast source such as the unicast server 112. In a particular embodiment, the configuration server 110 may communicate with the unicast server 112. The unicast server 112 may initiate a configuration data request to the configuration web server 110 that may provide configuration data to the unicast server 112, such as an indication of data blocks that are to be provided by the unicast server 112 to the computing device 102 by unicast transmission.

The content request proxy 106 may initiate a request to the multicast server 114 to join one or more multicast groups in order to receive data blocks that are to be included in the requested content. In response, the multicast server 114 may provide the requested data blocks. In a particular illustrative embodiment, the content request proxy 106 determines whether the requested content is available at least in part via the multicast groups by identifying one or more closest multicast sources to the computing device 102. In a particular illustrative embodiment, the proxy 106 can identify the one or more closest multicast sources from information provided in the content table. Multicast sources that are closer to the content reception device 101 may provide portions of the requested content more quickly than multicast sources that are further from the content reception device 101.

In a particular illustrative embodiment, the content request proxy 106 initiates a unicast request of data blocks to the unicast server 112. For example, if some data blocks of the requested content are unavailable by multicast transmission, the proxy 106 can issue the request of those data blocks unavailable by multicast transmission to be transmitted by unicast transmission. In response, the unicast server 112 provides the requested data blocks to the proxy 106.

The computing device 102 may thus receive the requested content via multicast transmission, or by a combination of multicast transmission and unicast transmission. For example, the computing device 102 may receive a first portion of the requested content from one or more unicast sources and may receive a second portion of the requested content from one or more multicast sources in one or more multicast groups. The proxy 106 may provide the requested content to the content request software 104. The content request software 104 can provide the requested content as an output of the computing device 102 to the content reception device 101 to be displayed on a display device (not shown). In a particular illustrative example, the computing device 102 buffers an initial part of the first portion of content received from a unicast source prior to receiving the second portion of the content from the multicast sources. By buffering the initial part of the requested content, an uninterrupted stream of data blocks may be provided to a display device.

In a particular illustrative embodiment, prior to providing the requested content, the proxy 106 sequences the received data blocks according to a pre-determined sequence. For example, the predetermined sequence can be specified so as to enable the requested content to be reassembled according to an intended temporal sequence of presentation. The proxy 106 may then supply the requested content in sequenced order to the content request software 104, as a content response 107. The content response 107 includes portions of the requested content that have been received from a multicast source.

Thus, the proxy 106 provides a content response 107 to the content unicast request 105. The content response 107 may include a plurality of sequenced content data blocks that have been received from a combination of multicast sources and unicast sources.

In a particular illustrative embodiment, the proxy 106 selects multicast sources that are closer to the computing device 102, in order to more efficiently gather the requested content. Also, the proxy 106 may receive some portion of the requested content from one or more unicast sources that may be selected as those that are closer to the computing device 102, in order to more efficiently amass the requested content data blocks.

In operation, the content reception device 101 may receive a content request from a user. The computing device 102 inputs the content request, executes the content request software 104 that issues the content unicast request 105, and the proxy 106 executed on the computing device 102 locates and retrieves the requested content from a combination of multicast and unicast sources, selecting those sources that are closer to the computing device 102. The proxy 106 receives a complete set of content data blocks from one or more sources that can include multicast sources. The proxy 106 can sequentially order the received data blocks and can then supply the ordered sequenced complete set of data blocks to the content request software 104 which in turn outputs the requested content to be output from the content reception device 101.

In a particular illustrative embodiment, each transmitted data block from a multicast source has associated verification data, such as an associated checksum, that can be compared with a calculated checksum (calculated at the computing device 102) of a corresponding received data block. If the associated checksum does not agree with the calculated checksum of the received data block, the received data block is deemed unacceptable, and a replacement data block is retrieved from, e.g. a unicast source. By utilizing multicast sources, improved data transfer may result. Unicast sources can be utilized to provide a portion of the requested content when data checksums fail, or when some of the requested content is unavailable from the multicast sources.

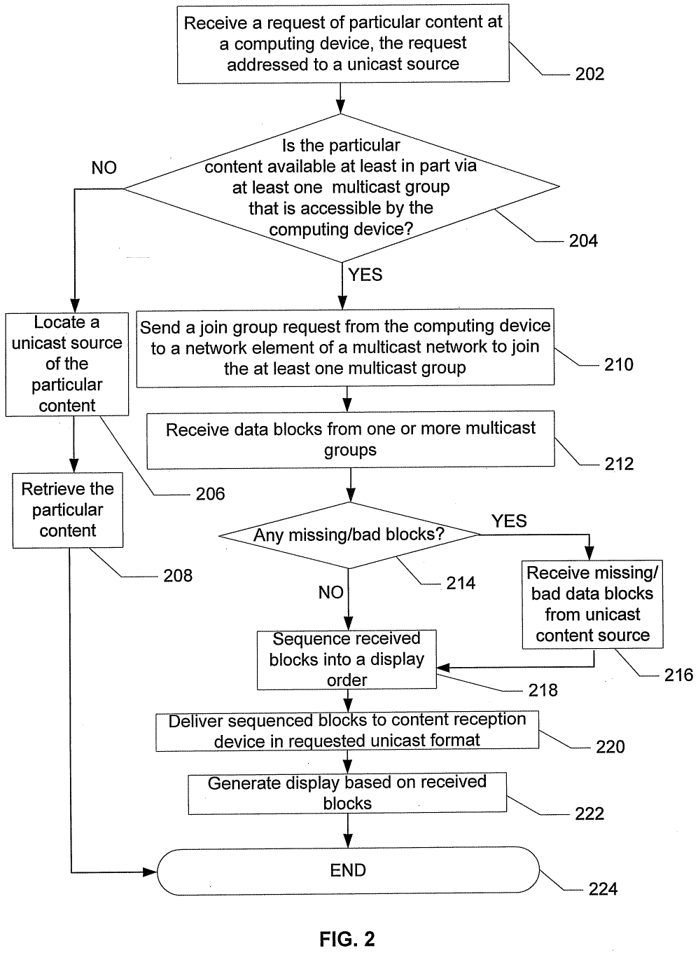

FIG. 2 is a flow diagram of a first embodiment of a method to provide content. At 202, a content request is received at a computing device. The request is addressed to a unicast source. Proceeding to decision block 204, a query is made as to whether the requested content is available at least in part via at least one multicast group that is accessible by the computing device. If the requested content is not available by at least one multicast group accessible by the computing device, the method proceeds to 206, and a unicast source is located to supply the requested content. Proceeding to 208, the requested content is retrieved from the unicast source, and the method terminates at 222.

Returning to decision block 204, if the requested content is at least partially available by at least one multicast group that is accessible by the computing device, a join group request is sent from the computing device to a network element of a multicast network, at 210. The join group request is sent in order to join at least one multicast group. Moving to 212, data blocks from one or more multicast groups are received by the computing device. Proceeding to decision block 214, it is determined whether there are any missing data blocks that are part of the requested content and have not yet been received or that have bad data blocks whose calculated checksum value differs from a checksum value associated with a corresponding data block transmitted from the multicast source. If there are any data blocks that are missing or bad, the missing/bad data blocks are received from one or more unicast content sources, at 216. Proceeding to 218, the received data blocks, including data blocks received from the one or more multicast sources and one or more unicast content sources, are sequenced into a predetermined sequence (display order). In a particular illustrative embodiment, the data blocks come from a combination of sources and are sequenced to provide the requested content in a predetermined temporal sequence. Moving to 220, the sequenced data blocks are delivered to a content reception device, such as the content reception device 101, in a requested unicast format. For example, if at 202 the content was requested to be in HTTP format, the sequenced data blocks are delivered to the content reception device in HTTP format. Proceeding to 222, a display is generated at the content reception device based on the received data blocks. The method ends at 224.

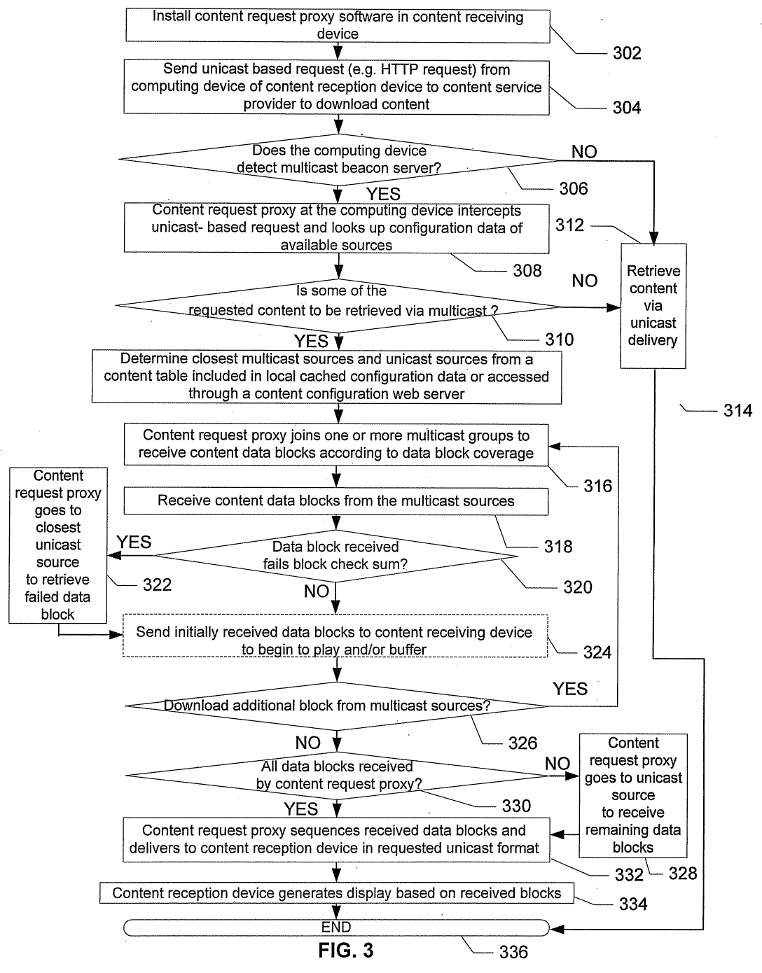

FIG. 3 is a flow diagram of a second embodiment of a method to provide content. At 302, content request proxy software is installed in a content receiving device. In a particular embodiment, the content request proxy software is installed in a computing device within the content receiving device. Proceeding to 304, the computing device sends a unicast based request, such as a HTTP request, directed to a content service provider to download the content. In a particular illustrative embodiment, the unicast-based request is generated by content request software such as the content request software 104 of FIG. 1, and the unicast-based request is sent to the content request proxy 106 of FIG. 1. Moving to decision block 306, a query is made as to whether the computing device detects a multicast beacon server. If the computing device does not detect the multicast beacon server, the requested content is retrieved via a unicast delivery, at 312. The method ends at 334.

Returning to decision block 306, if the computing device detects the multicast beacon server, proceeding to 308, a content request proxy at the computing device intercepts the unicast based request and looks up configuration data of available sources of the requested content. In a particular illustrative embodiment, the content request proxy is software executed by the computing device. Moving to 310, it is determined whether at least a portion of the requested content can be retrieved via multicast transmission. If the requested content cannot be retrieved by a multicast transmission, proceeding to 312, the content is retrieved via a unicast delivery and the method terminates at 334. If, however, at decision block 310, it is determined that a portion of the requested content can be retrieved via multicast transmission, sources (including multicast sources and unicast sources) that are closer to the computing device are determined from a content table, at 314. The content table may be included in locally cached configuration data, or may be accessed through a content configuration web server. For example, it can be determined that one or more multicast sources are closer to the computing device than others and are therefore preferred sources to provide at least a portion of the requested content.

Advancing to 316, the content request proxy joins one or more multicast groups to receive content data blocks according to data block coverage. For example, one of the multicast groups may be able to provide a first portion of the requested content, and a second multicast group may be able to provide a second portion of the requested content. Proceeding to 318, the content data blocks are received from the providing multicast sources.

Advancing to 320, the method determines whether each data block received has failed a data block checksum by comparison to metadata transmitted with the data block. If a particular data block has failed a checksum, proceeding to 322, the content request proxy communicates with a closest unicast source to retrieve the failed data block. Initially received data blocks can optionally be sent to the content receiving device, at 324. The content receiving device can begin outputting the initially received data blocks, or can buffer the initially received data blocks. By buffering the initially received data blocks in the content receiving device, a display may be commenced while additional data blocks of the requested content are being received.

Returning to decision block 320, if all received data blocks pass their corresponding checksum verification, the initially received data blocks are sent to the content receiving device to commence presentation and/or to be buffered, at 324. Proceeding to decision block 326, it is determined whether there are additional data blocks of the requested content to be downloaded from multicast sources. If there are additional data blocks to be received or to be downloaded from multicast sources, returning to 316, the content request proxy joins one or more additional multicast groups to receive the additional data blocks. If all data blocks that can be received from multicast sources have been received, proceeding to decision block 330, the method evaluates whether all data blocks that are associated with the requested content have been received. If some data blocks of the requested content have not been received, proceeding to 328, the content request proxy communicates with a closest unicast source to receive the remaining data blocks to be received. Returning to decision block 330, if all data blocks included in the requested content have been received, the method proceeds to 332. Also, if additional data blocks have been requested from a closest unicast source, after the remaining data blocks have been received, the method proceeds to 332. At 332, the content request proxy sequences all received data blocks into a pre-determined sequence and delivers the sequenced data blocks to a display device in a requested unicast format, such as an HTTP format. Proceeding to 334, the content reception device generates a display based on the received data blocks. The method terminates at 336.

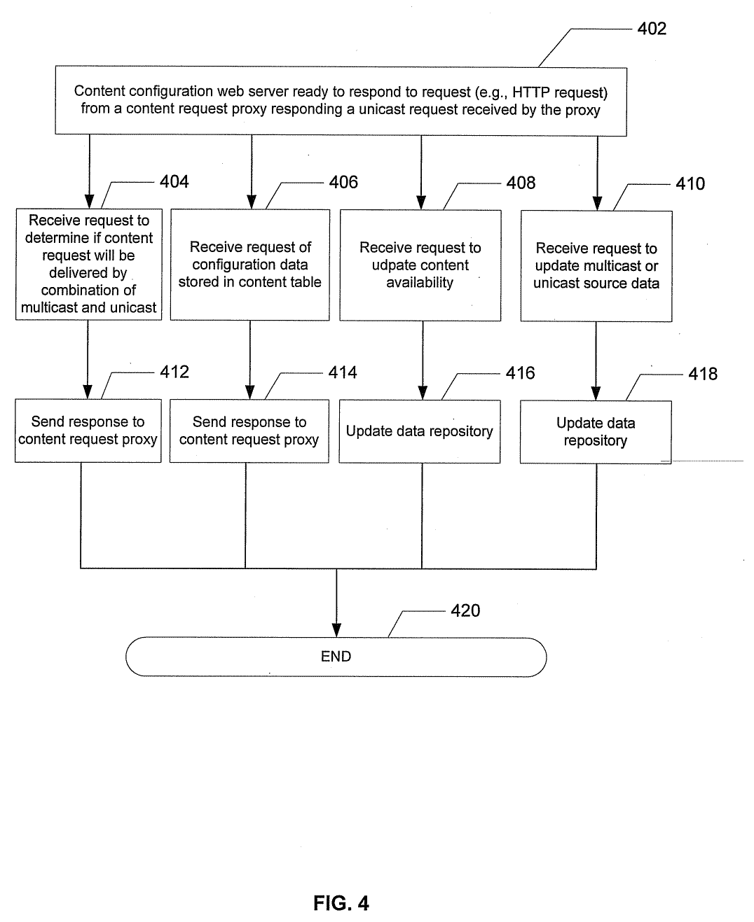

FIG. 4 is a flow diagram of a third embodiment of a method to provide content. At 402, a content configuration web server is ready to respond to a request, such as a HTTP request from a content request proxy that responds to a unicast-based request received by the proxy. The method can proceed along one of several parallel routes. Proceeding to 404, a content configuration web server receives a request to determine if the content request can be delivered by a combination of multicast and unicast transmissions. Advancing to 412, the content configuration web server sends a response to the content request proxy and the method ends at 420. At a second path, the method proceeds from 402 to 406, where the configuration web server receives a request of configuration data stored in a content table. The method advances to 414 where the content configuration web server sends a response to the content request proxy, and the method ends at 420. A third parallel path continues from 402 to 408, in which the content configuration web server receives a request to update content availability. The method proceeds to 416, updating a data repository. The method ends at 420. Along a fourth path, the method proceeds from 402 to 410, and the content configuration web server receives a request to update multicast or unicast source data indicating what content is available from each content server. Advancing to 418, the data is updated in the data repository. The method ends at 420.

In operation, a content reception device, such as content reception device 101 of FIG. 1, may initiate a content request through a computing device 102 that may execute content request software 104 and a content request proxy 106. The computing device 102 may generate a content unicast request based on a content request that has been received by the content reception device 101. In a particular illustrative embodiment, the content request proxy 106 is a software application that is executed by the computing device 101. The content request proxy can issue a configuration data request to determine sources of the requested content. The content request proxy can determine if there are one or more multicast sources that can provide at least a portion of the requested content. In a particular illustrative embodiment, the requested content is deliverable as one or more data blocks. The content request proxy can determine that some or all of the requested content is available by multicast transmission. In a particular embodiment, the content request proxy can determine closest multicast sources and join multicast groups including the closest multicast sources in order to retrieve the requested content or portions thereof. If portions of the requested content are unavailable by multicast transmission, the content request proxy can request the unavailable portions to be received by unicast transmission. When the content request proxy has received all portions of the requested content, the content request proxy can sequence the received data blocks according to a pre-determined sequence such as a predetermined temporal sequence. The content request proxy can send a response to the unicast-based request that includes the sequenced data blocks of requested content to the content request software, which in turn makes available the sequenced data blocks to the content reception device in order to be displayed. In a particular illustrative embodiment, an initial portion of the requested content is received by unicast transmission and is buffered by the computing device to be provided prior to providing the portion of the content received by multicast transmission.

The content request proxy can determine availability of portions of requested content by sending a configuration data request to a configuration web server, which accesses a content table to determine one or more available sources of the requested content. In a particular illustrative embodiment, when there are one or more multicast sources that can provide at least a portion of the requested content, the content request proxy can join associated multicast groups of the multicast servers to provide the requested content or portions thereof. When a portion of the requested content is unavailable by multicast transmission, the content request proxy can issue a unicast request of the portions of requested content that are unavailable by multicast transmissions. The content request proxy retrieves all data blocks including those from multicast transmission and unicast transmission. Each of the content data blocks can be checked against verification data related to the content data block, such as a corresponding data block checksum, to verify accurate transmission and reception of the corresponding data block. The verification data can be based on entries in a content table accessible via a multicast network that provides access to the associated multicast groups. Any data block failing checksum verification may be re-requested to be received via unicast transmission. The content request proxy sequences the received data blocks to produce the requested content that is output to a display device.

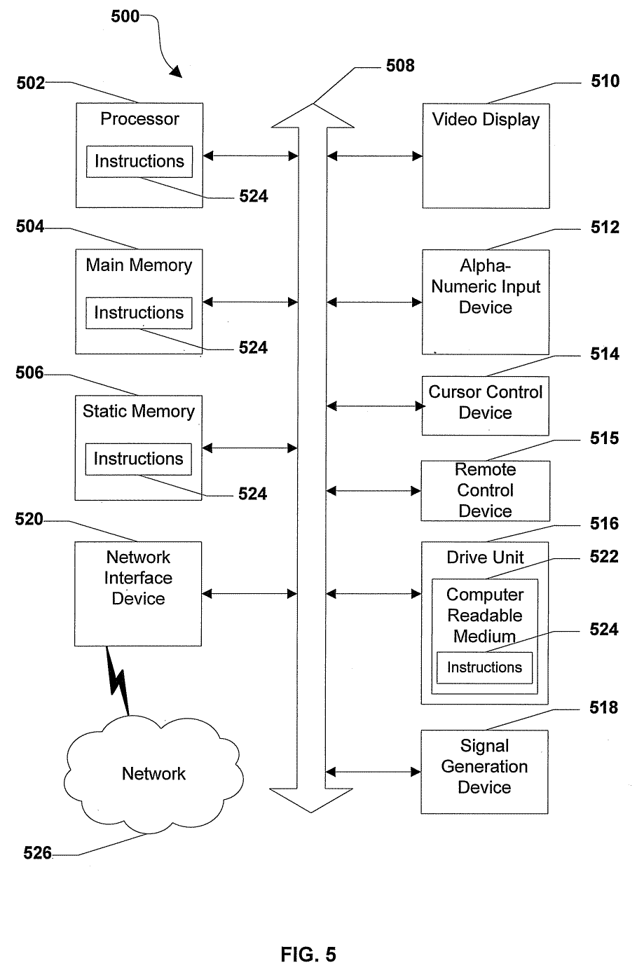

FIG. 5 is a general diagram of a particular illustrative embodiment of a computer system 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems, or peripheral devices, including a Telephone Number Mapping (ENUM) server, a Home Subscriber Server (HSS), components of an Internet Protocol Multimedia System (IMS).

In a networked deployment, the computer system may operate in the capacity of a content source, a network management system, a server, set-top box device, or network switch. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video, audio, or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506, which can communicate with each other via a bus 508. As shown, the computer system 500 may further include a video display unit 510, such as a liquid crystal display (LCD), a flat panel display, a solid state display, a plasma display device, or a video projector. Additionally, the computer system 500 may include an input device 512, such as a keyboard, a cursor control device 514, such as a mouse, and a remote control device 515. The computer system 500 can also include a disk drive unit 516, a signal generation device 518 such as a speaker, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal so that a device connected to a network 526 can communicate voice, video, audio, or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile memories. Further, the computer-readable medium can be a random access memory or other volatile re-writable memory. Additionally, the computer-readable medium can include a magneto-optical or optical medium, such as a disk or tape or other storage device to capture carrier wave signals such as a signal communicated over a transmission medium. A digital file attachment to an e-mail or other self-contained information archive or set of archives may be considered a tangible storage medium. Accordingly, the disclosure is considered to include any one or more of a computer-readable medium or other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP), video standards (e.g., MPEG-2, MPEG-4, H.262, AVC, AVS), and encryption standards (e.g., AES, DES) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving a request of particular content at a computing device, wherein the request is addressed to a unicast source;
determining whether the particular content is available at least in part via at least one multicast group accessible by the computing device; and
when the particular content is available at least in part via the at least one multicast group, sending a group join request from the computing device to a network element of a multicast network to join the at least one multicast group.

2. The method of claim 1, further comprising receiving data blocks of the particular content via the at least one multicast group.

3. The method of claim 1, further comprising:
receiving data blocks of the particular content via a plurality of multicast groups; and
sequencing the received data blocks into a display order.

4. The method of claim 3, further comprising generating a display based on the received data blocks.

5. The method of claim 3, further comprising, when a data block of the particular content is missing from the plurality of multicast groups, requesting the missing data block from the unicast source.

6. The method of claim 1, further comprising when the particular content is not available via the at least one multicast group, sending the request of particular content to the unicast source.

7. The method of claim 1, wherein receiving the request of particular content comprises receiving user input at the computing device, the user input indicating selection of the particular content to be displayed at the computing device.

8. A computing device comprising:
an input to receive a request of particular content, wherein the request is addressed to a unicast source; and
proxy logic to determine whether the particular content is available at least in part via at least one multicast group accessible by the computing device, wherein when the particular content is available at least in part via the at least one multicast group, the computing device is configured to send a group join request to a network element of a multicast network to join the at least one multicast group.

9. The computing device of claim 8, wherein the proxy logic is operative to determine whether the particular content is available at least in part via at least one multicast group accessible by determining whether the computing device is coupled to a multicast network.

10. The computing device of claim 9, wherein the proxy logic determines whether the computing device is receiving a multicast beacon.

11. The computing device of claim 8, wherein the proxy logic accesses a content table, wherein the content table indicates content availability from each of a plurality of multicast groups.

12. The computing device of claim 11, wherein the proxy logic is operative to identify one or more closest multicast sources from the content table.

13. The computing device of claim 11, wherein the proxy logic is operative to identify one or more closest unicast sources from the content table.

14. The computing device of claim 11, wherein the content table is accessed through a configuration web server.

15. The computing device of claim 14, wherein the content table is updated at the configuration web server by input from at least one of a multicast server, a unicast server, a configuration data repository, and an administrator.

16. The computing device of claim 8, wherein the input is adapted to receive a first portion of the particular content from the unicast source and to receive a second portion of the particular content from the at least one multicast group.

17. The computing device of claim 16, further comprising memory to buffer an initial part of the first portion prior to receiving the second portion.

18. A computer-readable medium including computer-executable instructions that when executed, cause the computer to:
receive a request of particular content at a computing device, wherein the request is addressed to a unicast source;
determine whether the particular content is available at least in part via at least one multicast group accessible by the computing device; and
when the particular content is available at least in part via the at least one multicast group, send a group join request to a network element of a multicast network to join the at least one multicast group.

19. The computer-readable medium of claim 18, further comprising instructions to determine, based on a content table accessible through the multicast network, verification data related to the particular content, wherein the verification data includes information to verify that the particular content is received.

20. The computer-readable medium of claim 19, wherein the verification data includes one or more checksums.
